(19) United States
(12) Patent Application Publication
(10) Pub. No.: US 2013/0071177 A1
(43) Pub. Date: Mar. 21, 2013

(54) WRENCH QUICK RELEASE APPARATUS

(71) Applicant: TING-JUI WANG, NEW TAIPEI CITY (TW)

(72) Inventor: TING-JUI WANG, NEW TAIPEI CITY (TW)

(73) Assignee: DTECH PRECISION INDUSTRIES CO., LTD.

(21) Appl. No.: 13/344,127

(22) Filed: Jan. 5, 2012

(30) Foreign Application Priority Data
Sep. 16, 2011 (TW) 100217362

(51) Int. Cl. F16B 5/00

(52) U.S. Cl. 403/167

(57) ABSTRACT

A wrench quick release apparatus includes a sleeve, a positioning unit, a wrench unit and an elasticity unit. The sleeve includes a channel and an engaging section for engaging to a first plate. The positioning unit inserts in the channel of the sleeve, and includes one end inserted through the first plate and an opposite end extends out from the channel of the sleeve. The wrench unit is pivotally connected to the positioning unit and extends out from one end of the sleeve. The elasticity unit includes one end pushed against the positioning unit and an opposite end pushed against the sleeve. Accordingly, the wrench quick release apparatus is first engaged to the first plate through the sleeve and then engaged to or disengaged from a second plate to achieve a steady and quick assembly effect with minimal efforts in a convenient manner.

### CROSS-REFERENCE TO RELATED APPLICATION

This non-provisional application claims priority under 35 U.S.C. §119(a) on Patent Application No(s). 100217362 filed in Taiwan, R.O.C. on Sep. 16, 2011, the entire contents of which are hereby incorporated by reference.

### FIELD OF TECHNOLOGY

The present invention relates to a wrench quick release apparatus, and more particularly, to a wrench quick release apparatus for quickly assembling a first plate and a second plate.

### BACKGROUND

Various approaches for assembling two plate-like objects (e.g., a motherboard and a housing) are available. A common approach is fastening through a screw thread structure which generally comprises a screw, a cap and a sleeve. The screw comprises an end of a larger diameter as a force receiving section provided with a screw groove, and another end comprises a screw rod connected with the force receiving section. The cap is fitted around a hollow cylinder about the force receiving section for encapsulating and protecting the screw. The sleeve is a hollow cylinder for fitting the screw rod of the screw in a way that the sleeve and the cap are dynamically fitted. Accordingly, with a fastening unit, an end of the sleeve is first engaged to a first object (e.g., a motherboard), rendering the screw rod of the screw corresponded to a fastening opening of a second object (e.g., a housing), and a rotational force is applied to the screw groove of the force receiving section of the screw with the aid of a tool, so as to fasten the screw rod into the fastening opening of the second object and complete the assembly of the two objects. By contrast, a rotational force applied to the screw groove of the force receiving section of the screw with a tool is also required for disengaging the screw rod from the fastening opening of the second object.

However, as previously described, the above structure that completes fastening by a screw thread requires an additional tool for applying a rotational force to the screw groove of the force receiving section of the screw for engagement or disengagement, which means that corresponding engagement and disengagement procedures are more complex and time-consuming. Furthermore, although the prior art provides certain fastening approaches for assembling two objects, these conventional approaches involve fastening operations performed by manual forces that directly press fastening units. Consequently, not only a fastening process of such conventional approach is rather laborious and unpractical, but also utilization inconvenience is resulted due to a lack of force applying section when disengaging the fastening units in reverse.

In view of the above, there is a need for a solution for overcoming the drawbacks associated with the prior art.

### SUMMARY

Therefore, the present invention provides a wrench quick release apparatus for steadily and quickly assembling a first plate and a second plate with minimal efforts in a convenient manner.

It is an object of the present invention to provide a wrench quick release apparatus comprising a sleeve, a positioning unit, a wrench unit and an elasticity unit. The wrench quick release apparatus is first engaged to a first plate via the sleeve then engaged to or disengaged from the second plate with the positioning section of the positioning unit through rotations of the wrench unit, so as to quickly and steadily assemble the first plate with the second plate with minimal efforts in a convenient manner.

To achieve the above object, according to a preferred embodiment of the present invention, the wrench quick release apparatus for first engaging a first plate and then engaging a second plate to assemble the first plate with the second plate comprises: a sleeve, comprising a first end, a second end opposite to the first end and a channel connecting to the first end and the second end, the first end comprising an engaging section for engaging the first plate; a positioning unit, being a column body movably inserted in the channel of the sleeve, comprising a positioning end extending to the first end of the sleeve, a positioning section provided at the positioning end and for engaging with the second plate, and an activating end opposite to the positioning end and extending out of the second end of the sleeve; a wrench unit, comprising a wrench section and a pushing section connected to the wrench section, the pushing section being movably and pivotally connected to the activating end of the positioning unit such that when the wrench unit is rotated to push the pushing section against the second end of the sleeve, the positioning end and the positioning section of the positioning unit are given impetus for extension or contraction; and an elasticity unit, being fitted around the positioning unit, having its one end pushed against the positioning unit and its another end pushed against the sleeve.

In the wrench quick release apparatus according to an embodiment of the present invention, the pushing section of the wrench unit comprises a pivot groove and a pivot inserted through the pivot groove. The pivot groove is fitted around the activating end of the positioning unit, and the pivot is inserted through the activating end of the positioning unit.

In the wrench quick release apparatus according to an embodiment of the present invention, the positioning section of the positioning unit is a positioning column inserted in the second plate.

In the wrench quick release apparatus according to an embodiment of the present invention, the positioning section of the positioning unit is a threaded column fastened to the second plate.

In the wrench quick release apparatus according to an embodiment of the present invention, the positioning section of the positioning unit is at least two elastic fastening bodies each comprising at its one side a protruding fastening section for fastening to the second plate.

In the wrench quick release apparatus according to an embodiment of the present invention, the positioning section of the positioning unit is a hook for fastening to the second plate.

In the wrench quick release apparatus according to an embodiment of the present invention, the engaging section of the sleeve comprises a press-in section for installing to the first plate.

In the wrench quick release apparatus according to an embodiment of the present invention, the engaging section of the sleeve is a welding section for welding to the first plate.

In the wrench quick release apparatus according to an embodiment of the present invention, the engaging section of the sleeve comprises a flare-in section for installing to the first plate.

In the wrench quick release apparatus according to an embodiment of the present invention, the engaging section of the sleeve comprises a fastening section for fastening to the first plate. The fastening section comprises a first screw thread at the channel and a positioning element fastened to the first screw thread, and the positioning element comprises a second screw thread matching the first screw thread. The engaging section of the sleeve first accommodates one side of the first plate and the fastening element then fastens the other side of the first plate to fasten the second screw thread to the first screw thread.

In the wrench quick release apparatus according to an embodiment of the present invention, the sleeve is not provided with the engaging section, and the first end of the sleeve is integrally formed on the first plate such that the channel connects the first plate and the second end.

In the wrench quick release apparatus according to an embodiment of the present invention, the pushing section of the wrench unit is movably and pivotally connected to the second end of the sleeve. When the wrench unit is rotated to push the pushing section against the activating end of the positioning unit, the positioning end and the positioning section of the positioning unit are given impetus for extension and contraction. A wall of the second end of the sleeve is provided with two corresponding pivot sections, between which the pushing section of the wrench unit is movably and pivotally connected such that the pushing section is pushed against the activating end of the positioning unit.

Therefore, with the wrench quick release apparatus of the present invention, the engaging section of the sleeve is engaged to the first connecting opening of the first plate by means of installing or welding, and the positioning unit is driven by rotating the wrench unit so that the positioning section of the positioning unit passes through the first connecting opening of the first plate to engage to the second connecting opening of the second plate by means of inserting, locking, fastening or hooking. Thus, two objects are quickly and steadily assembled with minimal efforts in a convenient manner.

### BRIEF DESCRIPTION

The present invention will become more readily apparent to those ordinarily skilled in the art after reviewing the following detailed description and accompanying drawings, in which:

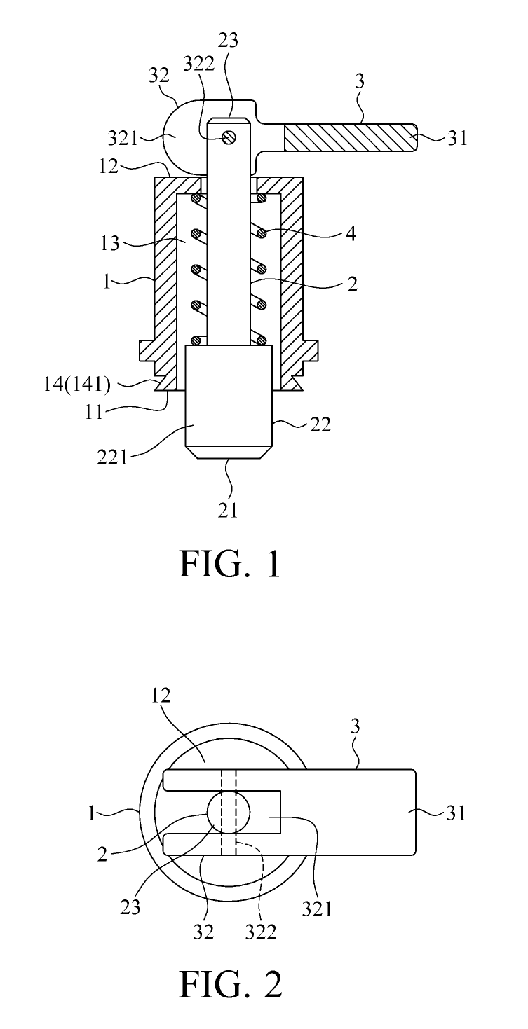

FIG. 1 is a sectional view according to a first preferred embodiment of the present invention;

FIG. 2 is a top view according to the first preferred embodiment of the present invention;

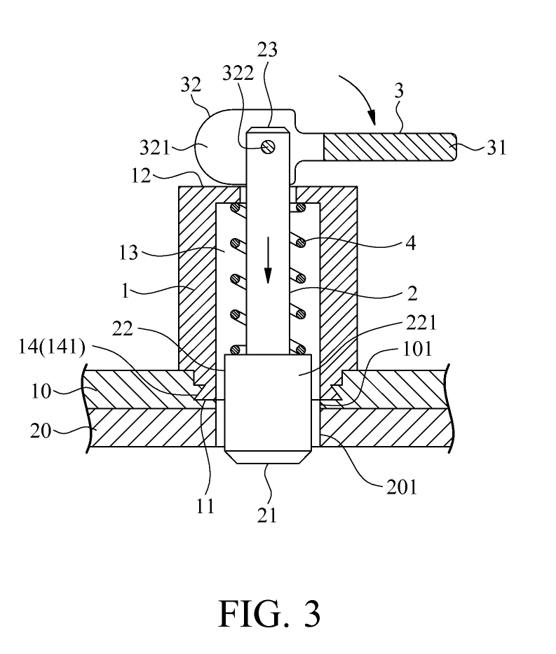

FIG. 3 is a schematic diagram illustrating applications and operations according to the first preferred embodiment of the present invention;

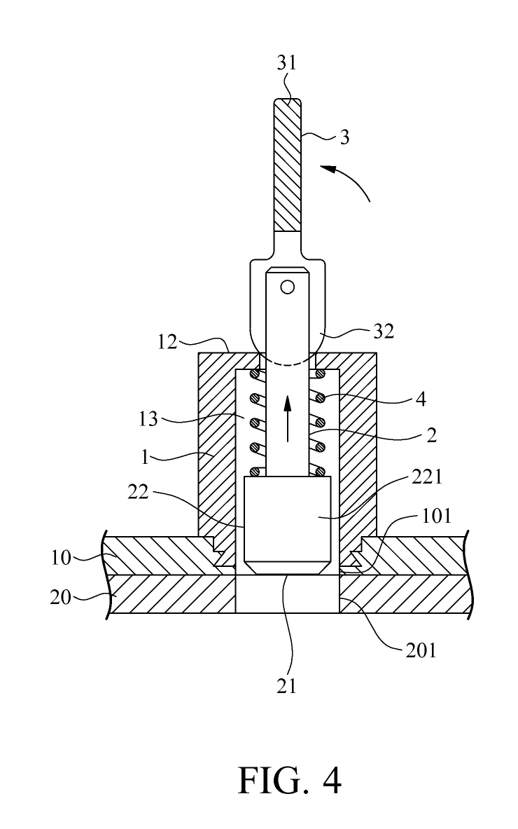

FIG. 4 is another schematic diagram illustrating applications and operations according to the first preferred embodiment of the present invention;

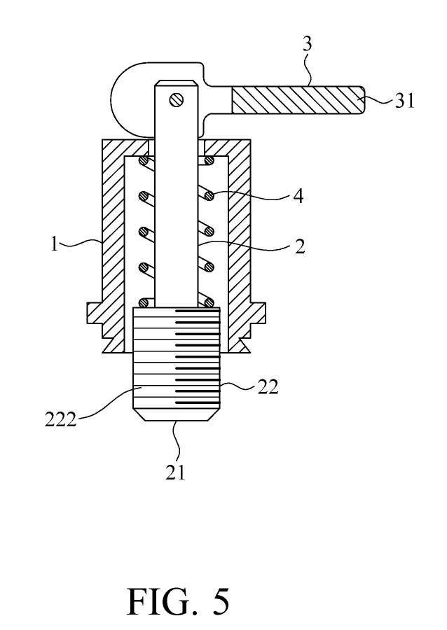

FIG. 5 is sectional view of a positioning section according to a second preferred embodiment of the present invention;

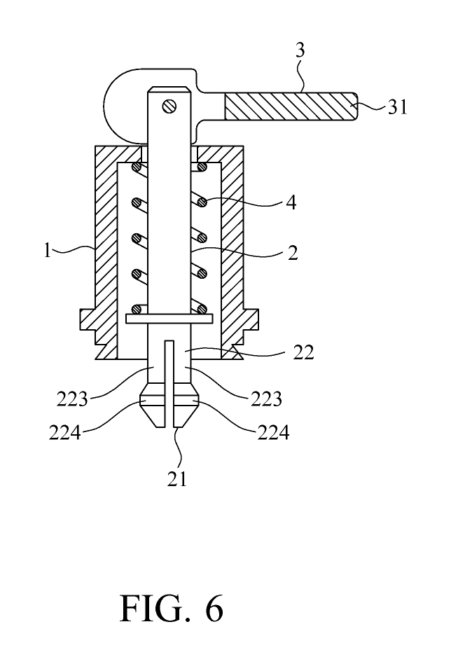

FIG. 6 is sectional view of a positioning section according to a third preferred embodiment of the present invention;

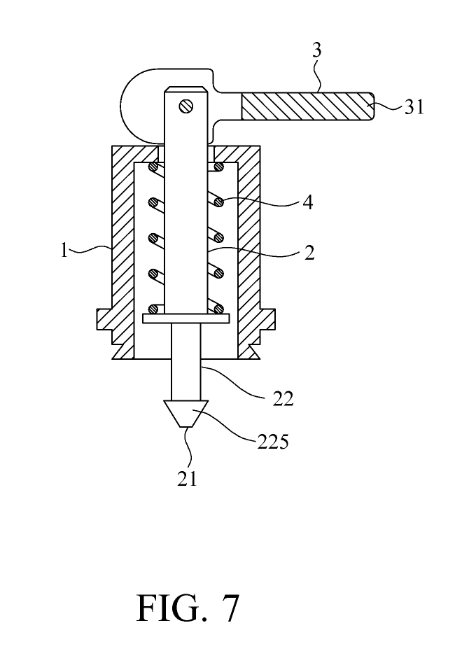

FIG. 7 is sectional view of a positioning section according to a fourth preferred embodiment of the present invention;

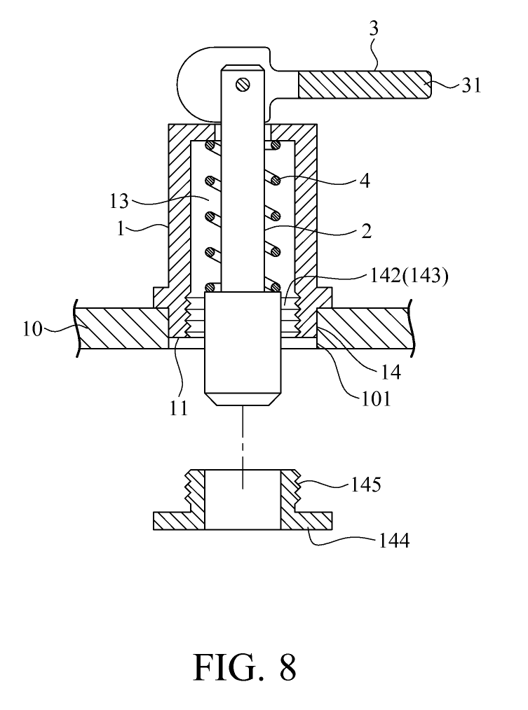

FIG. 8 is a sectional view of a fastening structure of a sleeve and a first plate according to a preferred embodiment of the present invention;

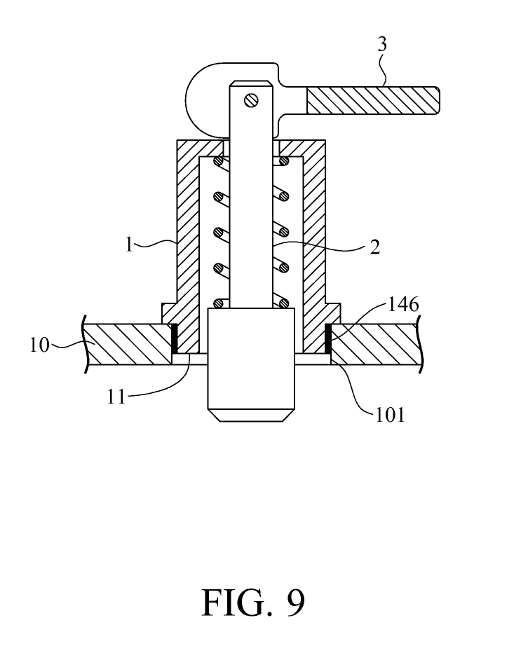

FIG. 9 is a sectional view of a welded structure of a sleeve and a first plate according to a preferred embodiment of the present invention;

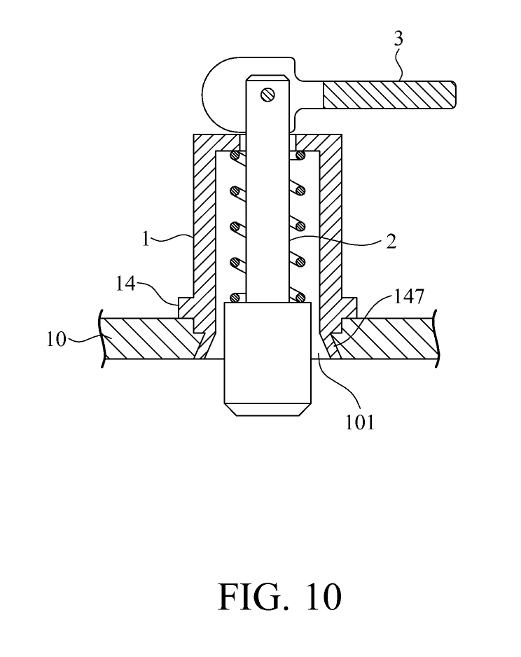

FIG. 10 is a sectional view of a flare-in structure of a sleeve and a first plate according to a preferred embodiment of the present invention;

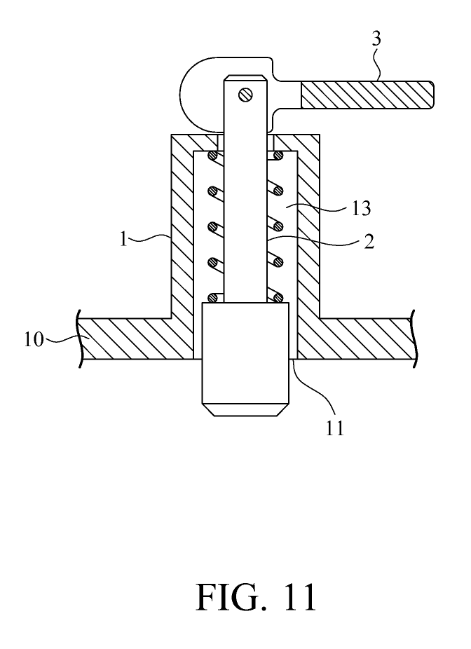

FIG. 11 is a sectional view of an integral structure of a sleeve and a first plate according to a preferred embodiment of the present invention;

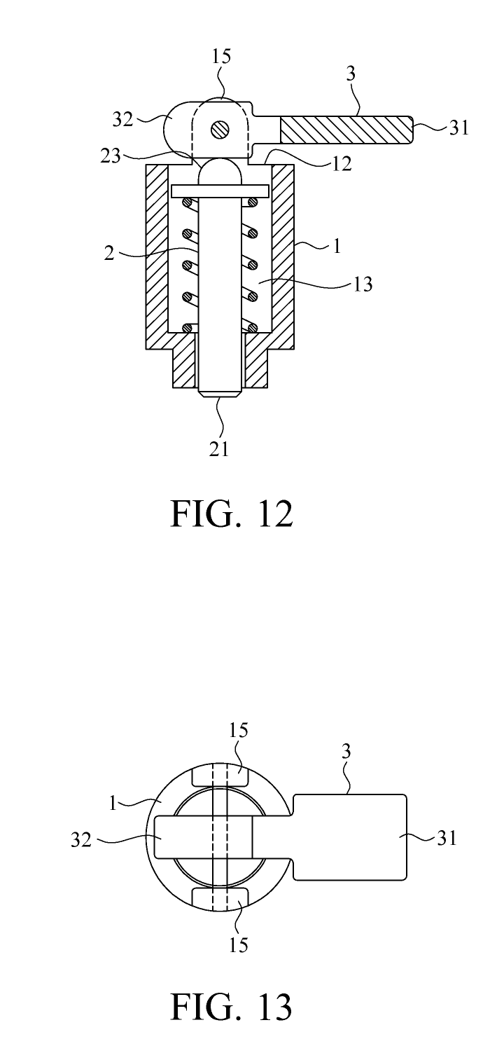

FIG. 12 is a sectional view of a wrench unit pivotally connected to a sleeve according to a preferred embodiment of the present invention;

FIG. 13 is a top view of a wrench unit pivotally connected to a sleeve according to a preferred embodiment of the present invention;

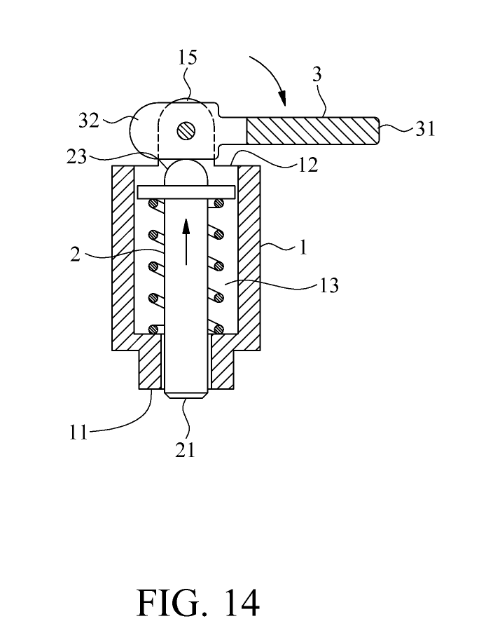

FIG. 14 is a schematic diagram illustrating rotation operations of a wrench unit pivotally connected to a sleeve according to a preferred embodiment of the present invention; and

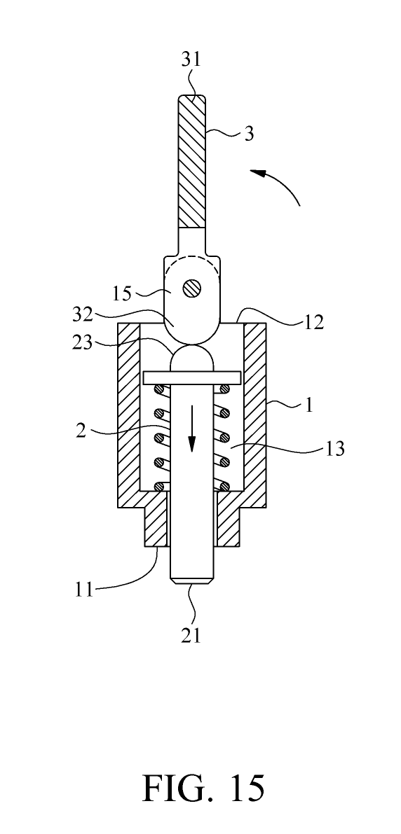

FIG. 15 is another schematic diagram illustrating rotation operations of a wrench unit pivotally connected to a sleeve according to a preferred embodiment of the present invention.

### DETAILED DESCRIPTION

FIGS. 1, 2 and 3 show schematic diagrams of a wrench quick release apparatus according to an embodiment of the present invention. The wrench quick release apparatus is first engaged to a first plate 10 and then engaged to a second plate 20, so as to assemble the first plate 10 with the second plate 20. The wrench quick release apparatus according to a preferred embodiment of the present invention comprises a sleeve 1, a positioning unit 2, a wrench unit 3, and an elasticity unit 4. The sleeve 1 comprises a first end 11, a second end 12 opposite to the first end 11, a channel 13 connecting the first end 11 and the second end 12, and an engaging section 14 at the first end 11 for engaging to the first plate 10. The positioning unit 2, being a column body movably inserted in the channel 13 of the sleeve 1, comprises a positioning end 21 extending to the first end 11 of the sleeve 1, a positioning section 22 provided at the positioning end 21 and for engaging the second plate 20, and an activating end 23 opposite to the positioning end 21 and extending out from the second end 12 of the sleeve 1. The wrench unit 3 comprises a wrench section 31 and a pushing section 32 connected to an end of the wrench section 31. The pushing section 32, which may be shaped as an eccentric cam, an elliptic body, a column body or other equivalent shapes, is movably and pivotally connected to the activating end 23 of the positioning unit 2, such that when the wrench unit 3 is rotated to push the pushing section 32 against the second end 12 of the sleeve 1, the positioning end 21 and the positioning section 22 of the positioning 2 are given impetus for extension or contraction for disengaging from or engaging with the second plate 20. The elasticity unit 4, being a screw spring or an elastic unit of other forms fitting around the positioning unit 2, has its one end pushing against the positioning unit 2 and its another end pushing against the sleeve 1, so as to provide impetus to the positioning section 22 of the positioning unit 2 to further engage with the second plate 20.

As shown in FIGS. 1 and 2, the pushing section 32 of the wrench unit 3 comprises a pivot groove 321 at its center and a pivot 322 (bolt) inserted through the pivot groove 321. Thus, the pivot groove 321 is fitted around the activating end 23 of the positioning unit 2, and the pivot 322 is also inserted through the activating end 23 of the positioning unit 2, such that the pushing section 32 of the wrench unit 3 is movably and pivotally connected to the activating end 23 of the positioning unit 2. As a result, when the wrench unit 3 is rotated to push the pushing section 32 against the second end 12 of the sleeve 1, the positioning unit 2 is given impetus for contraction or extension.

Referring to FIG. 3, to apply the wrench quick release apparatus of the present invention, the engaging section 14 of the sleeve 1 is first engaged by riveting, for example, to a first connecting opening 101 of the first plate 10. Referring to FIG. 4, as the wrench section 31 of the wrench unit 3 is rotated, the pushing section 32 is rotated to push against the second end 12 of the sleeve 1 to further inwardly draw the positioning end 21 and the positioning section 22 of the positioning unit 2 into the sleeve 1. Again referring to FIG. 3, when a second connecting opening 201 of the second plate 20 is aligned with the first connecting opening 101 of the first plate 10, the wrench section 31 of the wrench unit 3 is again rotated to disengage the pushing section 32 from the second end 12 of the sleeve 1. Accordingly, elastic forces of elasticity unit 4 are applied to the positioning unit 2 to engage (i.e., by inserting) the positioning section 22 at the positioning end 21 to the second connecting opening 201 of the second plate 20, thereby quickly assembling the first plate 10 with the second plate 20. Furthermore, the wrench section 31 of the wrench unit 3 is capable of optimizing applied forces to achieve reduced-effort operations when driving the positioning unit 2. In addition, the quick assembly can be completed without any extra tools when applying the wrench quick release apparatus for assembling the first plate 10 and the second plate 20 to again enhance utilization convenience of the present invention.

As shown in FIGS. 1 and 3, the positioning section 22 of the positioning unit 2 may comprise a positioning column 221 for inserting into the second opening 201 of the second plate 20 to achieve positioning and assembly effects. Alternatively, as shown in FIG. 5, the positioning section 22 of the positioning unit 2 may also comprise a threaded column 222 for fastening to the second plate 20, so that the positioning section 22 drives not only the positioning unit 2 for contraction and extension through the wrench unit 3 but also the threaded column 222 for fastening to the second connecting opening 201 (e.g., a screw opening) of the second plate 20. For another example shown in FIG. 6, the positioning section 22 of the positioning unit 2 may comprise at least two elastic fastening bodies 223 each comprising at its one side a protruding fastening section 224 for fastening to the second plate 20. Thus, when driven by the elasticity unit 4 or the wrench unit 3, the protruding fastening sections 224 of the positioning unit 2 may fasten the second plate 20. For another example shown in FIG. 7, the positioning section 22 of the positioning unit 2 may comprise a hook 225 for fastening the second plate 20. Similarly, the hook 225 may fasten the second plate 20 when driven by the elasticity unit 4 or the wrench unit 3.

It should be noted that various modifications may be made to the structure of the engaging section 14 of the sleeve 1 for engaging with the first plate 10 without departing from the spirit of the present invention, and that the various modifications are encompassed within the scope of the present invention. For example, referring to FIGS. 3 and 4 showing other embodiments of the present invention, the engaging section 14 of the sleeve 1 may comprise a press-in section 141 for installing to the first plate 10, or a fastening section 142 for fastening to the first plate 10. The fastening section 142 may be a screw thread for directly screwing and fastening to the first connecting opening 101 of the first plate 10. Alternatively, as shown in FIG. 8, the fastening section 142 comprises a first screw thread 143 at the channel 13 and a ring-shaped fastening element 144 fastened to the first screw thread 143, and the fastening element 144 is provided with a second screw thread 145 matching the first screw thread 143. Accordingly, the engaging section 14 of the sleeve 1 first accommodates one side of the first plate 10 and the fastening element 144 then fastens the other side of the first plate 10, so as to fasten the second screw thread 145 to the first screw thread 143 located in the channel 13 to further fasten the sleeve 1 to the first connecting opening 101 of the first plate 10. As shown in FIG. 9, in another embodiment of the present invention, the engaging section 14 of the sleeve 1 may comprise a welding section 146 for welding to the first connecting opening 101 of the first plate 10. Referring to FIG. 10 showing another embodiment of the present invention, the engaging section 14 of the sleeve 1 may comprise a flare-in section 147 for installing to the first connecting opening 101 of the first plate 10.

Referring to FIG. 11, by eliminating the engaging section 14, the first end 11 of the sleeve 1 may be integrally formed on the first plate 10 such that the channel 13 connects the first plate 10 and the second end 12 to achieve the same effects.

Referring to FIGS. 12 and 13 showing other embodiments of the present invention, the pushing section 32 of the wrench unit 3 may implemented as being movably and pivotally connected to the second end 12 of the sleeve 1 instead of being pivotally connected to the activating end 23 of the positioning unit 2. As shown in FIGS. 14 and 15, when the wrench unit 3 is rotated to push the pushing section 32 against the activating end 23 of the positioning unit 2, the positioning end 21 and the positioning section 22 of the positioning unit 2 are given impetus for extension and contraction. To allow the pushing section 32 with a movable and pivotal connection, a wall of the second end 12 of the sleeve 1 of the present invention is provided with two corresponding pivot sections 15. Thus, the pushing section 32 of the wrench unit 3 is movably and pivotally connected between the two pivot sections 15, and the pushing section 32 is pushed against the activating end 23 of the positioning unit 2 to propel the positioning unit 2 by rotation.

With the above embodiments, it is illustrated that the present invention provides a novel wrench quick release apparatus offering many advantages. Through the combination of the sleeve, the positioning unit, the wrench unit and the elasticity unit, the wrench quick release apparatus of the present invention is first engaged to the first plate through the sleeve and is then engaged to or disengaged from the second plate with the positioning section of the positioning unit through rotations of the wrench unit, so as to quickly and steadily assemble the first plate with the second plate with minimal efforts in a convenient manner.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A wrench quick release apparatus, for engaging with a first plate and then engaging with a second plate, comprising:
a sleeve, comprising a first end, a second end opposite to the first end, a channel connecting the first end and the second end, and an engaging section for engaging to the first plate;
a positioning unit, being a column body movably inserted in the channel of the sleeve, comprising a positioning end extending to the first end of the sleeve, a positioning section provided at the positioning end and for engaging to a positioning section of the second plate, and an activating end opposite to the positioning end and extending out from the second end of the sleeve;
a wrench unit, comprising a wrench section, and a pushing section connected to the wrench section and movably and pivotally connected to the activating end of the positioning unit, so as to give impetus to the positioning end and the positioning section of the positioning unit for extension and contraction when the pushing section is pushed against the second end of the sleeve by rotating the wrench unit; and
an elasticity unit, fitted around the positioning unit, comprising an end pushed against the positioning unit and another end pushed against the sleeve.

2. The wrench quick release apparatus as claimed in claim 1, wherein the pushing section of the wrench unit comprises a pivot groove and a pivot inserted through the pivot groove, the pivot groove is fitted around the activating end of the positioning unit, and the pivot is inserted through the activating end of the positioning unit.

3. The wrench quick release apparatus as claimed in claim 1, wherein the positioning section of the positioning unit is a positioning column inserted in the second plate.

4. The wrench quick release apparatus as claimed in claim 1, wherein the positioning section of the positioning unit is a threaded column fastened to the second plate.

5. The wrench quick release apparatus as claimed in claim 1, wherein the positioning section of the positioning unit is at least two elastic fastening bodies each comprising at its one side a protruding fastening section for fastening to the second plate.

6. The wrench quick release apparatus as claimed in claim 1, wherein the positioning section of the positioning unit is a hook for fastening to the second plate.

7. The wrench quick release apparatus as claimed in claim 1, wherein the engaging section of the sleeve is a press-in section for installing to the first plate.

8. The wrench quick release apparatus as claimed in claim 1, wherein the engaging section of the sleeve is a fastening section for fastening to the first plate.

9. The wrench quick release apparatus as claimed in claim 8, wherein the fastening section comprises a first screw thread at the channel and a fastening element fastened to the first screw thread, and the fastening element comprises a second screw thread matching the first screw thread; the engaging section of the sleeve first accommodates one side of the first plate and the fastening element then fastens another side of the first plate to fasten the second screw thread to the first screw thread.

10. The wrench quick release apparatus as claimed in claim 1, wherein the engaging section of the sleeve is a welding section for welding to the first plate.

11. The wrench quick release apparatus as claimed in claim 1, wherein the engaging section of the sleeve comprises a flare-in section for installing to the first plate.

12. The wrench quick release apparatus as claimed in claim 1, wherein the sleeve is not provided with the engaging section, and the first end of the sleeve is integrally formed on the first plate and the channel connects the first plate and the second end.

13. The wrench quick release apparatus as claimed in claim 1, wherein the pushing section of the wrench unit is movably and pivotally connected to the second end of the sleeve; so as to give impetus to the positioning end and the positioning section of the positioning unit for extension and contraction when the pushing section is pushed against the activating end of the positioning unit by rotating the wrench unit.

14. The wrench quick release apparatus as claimed in claim 13, wherein a wall of the second end of the sleeve is provided with two corresponding pivot sections, between which the pushing section of the wrench unit is movably and pivotally connected, and the pushing section is pushed against the activating end of the positioning unit.
